(19) United States
(12) Patent Application Publication
(10) Pub. No.: US 2023/0010463 A1
(43) Pub. Date: Jan. 12, 2023

(54) ANGLE FIXING FIXTURE

(71) Applicant: Guangzhou Fengsen Machinery Co., Ltd., Guangzhou (CN)

(72) Inventor: Tianci WEN, Zhangjiajie (CN)

(21) Appl. No.: 17/468,169

(22) Filed: Sep. 7, 2021

(30) Foreign Application Priority Data
Jul. 12, 2021 (CN) 202121583521.6

(51) Int. Cl. B25B 5/14; B25B 5/16

(52) U.S. Cl. CPC B25B 5/14; B25B 5/16

(57) ABSTRACT

An angle fixing fixture relates to the field of tooling fixtures and includes: a right-angled triangle shaped positioning block and clamping claws. Each the clamping claw is provided with a clamper, and a position of the clamper on the clamping claw is adjustable. Each the clamping claw is detachably connected to the positioning block. The clamper is located outside the positioning block, and a certain distance is left between the clamper and the positioning block. An end surface of an end of the clamper close to the positioning block is parallel to one of outer side surfaces of the positioning block. The number of the clamping claws is at least two. The angle fixing fixture can meet the need of 90 degrees connection of two plates as well as the needs of other angle connections, and has a simple structure and is easy to use.

### FIELD OF THE DISCLOSURE

The disclosure relates to the field of tooling fixtures, and more particularly to an angle fixing fixture.

### BACKGROUND OF THE DISCLOSURE

In woodworking or welding processing, two plates are often connected together at a certain angle, and two plates commonly are connected at 90 degrees (vertical connection). Generally, an L-shaped angle fixing fixture is used to position the two plates, and then the two plates are fixed together by bonding or welding. However, in an actual production process, there is also a need of connecting the two plates at 45 degrees or other angles. The conventional L-shaped angle fixing fixture can only meet the need of 90 degrees connection of two plates, but cannot meet the needs of other angle connections.

### SUMMARY OF THE DISCLOSURE

An objective of the disclosure is to solve the problems existing in the prior art and provide an angle fixing fixture, which can meet the need of 90 degrees connection of two plates, and can also meet the needs of other angle connections. The structure is simple and it is easy to use.

In order to achieve the above objective of the disclosure, technical solutions are proposed as follows.

Specifically, an angle fixing fixture includes a right-angled triangle shaped positioning block and clamping claws. Each of the clamping claws is disposed with a clamper and a position of the clamper on the clamping claw is adjustable, each of the clamping claws is detachably connected to the right-angled triangle shaped positioning block, the clamper is located outside of the right-angled triangle shaped positioning block and a certain distance is left between the clamper and the right-angled triangle shaped positioning block, and an end surface of an end of the clamper close to the right-angled triangle shaped positioning block is parallel to one of outer side surfaces of the right-angled triangle shaped positioning block.

Moreover, the number of the clamping claws is at least two.

In a preferred embodiment, three corners of the right-angled triangle shaped positioning block are respectively formed with chamfers.

In a preferred embodiment, each of the clamping claws is a L-shaped screw rod, the clamper is slidably connected to the L-shaped screw rod, the right-angled triangle shaped positioning block is formed with an insertion hole matched with the L-shaped screw rod, the L-shaped screw rod is disposed with a locking nut, and the locking nut is located at a side of the clamper away from the insertion hole.

In a preferred embodiment, a middle portion of the right-angled triangle shaped positioning block is formed with a triangular hole, and the insertion hole is a U-shaped hole formed on an inner wall of the triangular hole and communicated with the triangular hole.

In a preferred embodiment, each of three inner walls of the triangular hole is formed with more than one the U-shaped hole.

In a preferred embodiment, the locking nut is a knob nut.

In a preferred embodiment, one of acute angles of the right-angled triangle shaped positioning block is 45 degrees.

In a preferred embodiment, one of acute angles of the right-angled triangle shaped positioning block is 30 degrees.

In a preferred embodiment, each of three sides of the right-angled triangle shaped positioning block is formed with a graduated scale.

In a preferred embodiment, a top end of the right-angled triangle shaped positioning block is formed with a flange extending outward.

Compared with the prior art, beneficial effects of the embodiments of the disclosure may be as follows:

the embodiments each provide a special fixture for plates connection. Each the fixture can complete at most three angles of plate connections, including one right-angled connection and two acute-angled connections. Multiple sets of angle fixing fixtures can be made/fabricated according to needs to meet the requirements of right-angled connection and arbitrary acute-angled connection of plates. By abutting two plates against the two outer side surfaces of the right-angled triangle shaped positioning block and adjusting the positions of the clampers, the two plates can be fixed between the corresponding clampers and the right-angled triangle shaped positioning block, and then the two plates can be fixed together by bonding, welding or other method. The structure is simple and it is easy to use.

### BRIEF DESCRIPTION OF THE DRAWINGS

FIG. 1 is a schematic structural view of an angle fixing fixture according to an embodiment of the disclosure.

FIG. 2 is a schematic structural view of a clamping claw.

FIG. 3 is a schematic structural view of a right-angled triangle shaped positioning block.

FIG. 4 is a schematic structural view of another right-angled triangle shaped positioning block.

FIG. 5 is an use of state representative diagram of the angle fixing fixture for an 90 degrees connection.

FIG. 6 is an use of state representative diagram of the angle fixing fixture for an 45 degrees connection.

### DESCRIPTION OF REFERENCE SIGNS

1. right-angled triangle shaped positioning block, 11. insertion hole, 12. locking nut, 13. triangular hole, 14. flange, 2. clamping claw, 3. clamper, 4. plate.

### DETAILED DESCRIPTION OF EMBODIMENTS

In the following, the disclosure will be further explained in conjunction with specific embodiments. It should be understood that these embodiments are only used to illustrate the disclosure and not to limit the scope of the disclosure. In addition, it should be understood that after reading the content taught by the embodiments of the disclosure, those skilled in the art can make various changes or modifications to the disclosure, and these equivalent forms also fall within the scope defined by this application.

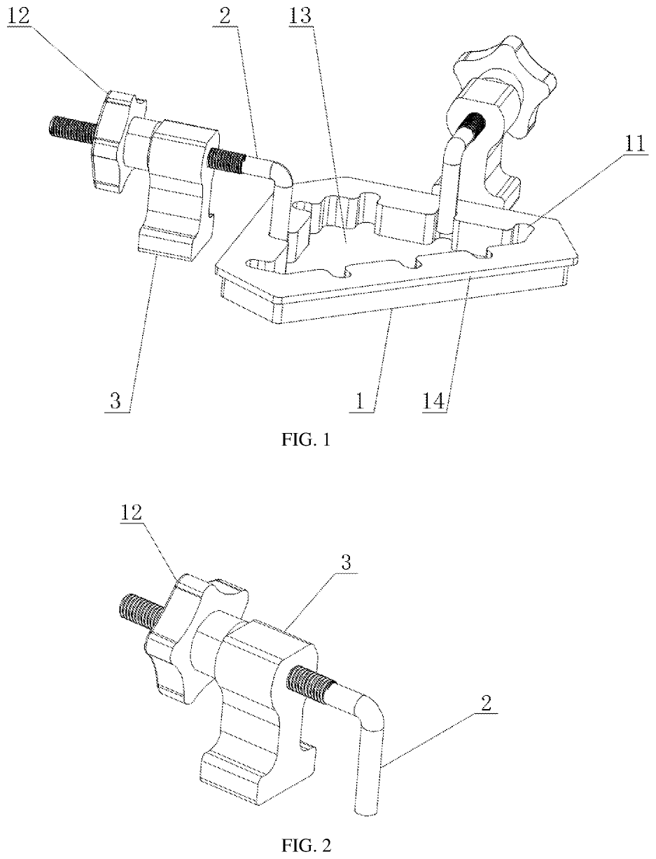

In an illustrated embodiment, as shown in FIG. 1, the angle fixing fixture associated with the disclosure may include a right-angled triangle shaped positioning block (also referred to as right-angled triangle shaped positioner) 1 and clamping claws 2.

In a preferred embodiment, three corners of the right-angled triangle shaped positioning block 1 are respectively formed with chamfers. On the one hand, it can reduce the weight of the right-angled triangle shaped positioning block 1 and reduce the cost. On the other hand, it can prevent sharp corners from hurting users and meanwhile it can prevent the right-angled triangle shaped positioning block 1 from directly contacting a joint of two plates 4, can prevent an adhesive drops on the right-angled triangle shaped positioning block 1 during bonding, can also avoid a deformation of the right-angled triangle shaped positioning block 1 caused by a high temperature of a welded place during welding, and can ensure a positioning accuracy of the right-angled triangle shaped positioning block 1.

Each of the clamping claws 2 is disposed with a clamper 3, and a position of the clamper 3 on the clamping claw 2 is adjustable, i.e., the clamper 3 is movably disposed on the clamping claw 2. Each of the clamping claws 2 is detachably connected to the right-angled triangle shaped positioning block 1. The clamper 3 is located outside the right-angled triangle shaped positioning block 1, and a certain distance is left between the clamper 3 and the right-angled triangle shaped positioning block 1. An end surface of an end of the clamper 3 near the right-angled triangle shaped positioning block 1 is parallel to one of outer side surfaces of the right-angled triangle shaped positioning block 1.

The clamping claws 2 are at least two in number/quantity, generally two clamping claws 2 are used, and more than two clamping claws can also be used as needed.

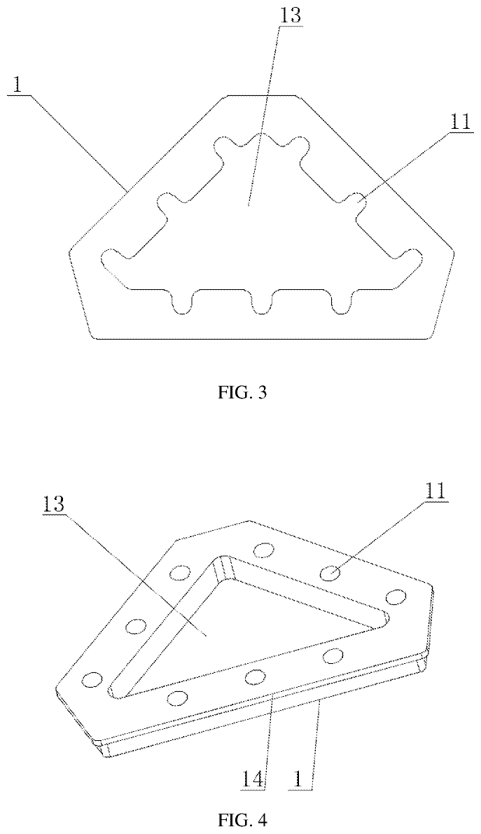

In a preferred embodiment, in order to facilitate disassembly and assembly of the clamping claw 2 and a positional adjustment of the clamper 3, each the clamping claw 2 is an L-shaped screw rod, and the clamper 3 is slidably connected to the L-shaped screw rod. In particular, the clamper 3 is provided with an through hole matched with the L-shaped screw rod, the right-angled triangle shaped positioning block 1 is provided/formed with insertion holes 11 (as shown in FIG. 3 and FIG. 4) matched with the L-shaped screw rod, a locking nut 12 is provided on the L-shaped screw rod, and the locking nut 12 is located on a side of the clamper 3 away from the socket 11.

Further, in order to facilitate manual adjustment of the locking nut 12, the locking nut 12 is a knob nut.

In a preferred embodiment, in order to reduce the weight of the right-angled triangle shaped positioning block 1, the middle portion of the right-angled triangle shaped positioning block 1 is provided with a triangular hole 13. Moreover, for the convenience of inserting the L-shaped screw rod into the insertion hole 11, the insertion holes 11 each are a U-shaped hole arranged on an inner wall of the triangular hole 13 and communicated with the triangular hole 13. In addition, in order to meet needs of connecting plates of different lengths, the three inner walls of the triangular hole 13 each are provided with several U-shaped holes. As shown in FIG. 3, a middle and two ends of each of the three inner walls of the triangular hole 13 are formed the U-shaped holes. In another embodiment, as shown in FIG. 4, the insertion hole 11 may be spaced from the triangular hole 13 instead.

In a preferred embodiment, in order to meet the requirement of connecting two plates at an angle of 45 degrees, one of acute angles of the right-angled triangle shaped positioning block 1 is 45 degrees.

In a preferred embodiment, in order to meet the requirement of connecting two plates at an angle of 30 degrees or 60 degrees, one of acute angles of the right-angled triangle shaped positioning block 1 is 30 degrees.

In a preferred embodiment, in order to facilitate a measurement of the length of the plate 4, scales are respectively provided on three sides of the right-angled triangle shaped positioning block 1.

In a preferred embodiment, for ease of use, a top end of the right-angled triangular shaped positioning block 1 is provided with a flange 14 extending outward. When in use, two of the outer side surfaces of the right-angled triangle shaped positioning block 1 abut against inner side surfaces of corresponding plates 4 respectively, and a bottom surface of the flange 14 abuts against top surfaces of the plates 4, which can prevent the right-angled triangle shaped positioning block 1 from falling between the two plates 4 and therefore is convenient for fixing the plates 4 and convenient to use.

Taking one of the acute angles of the right-angled triangular shaped positioning block 1 being 45 degrees as an example, when the angle fixing fixture is in use:

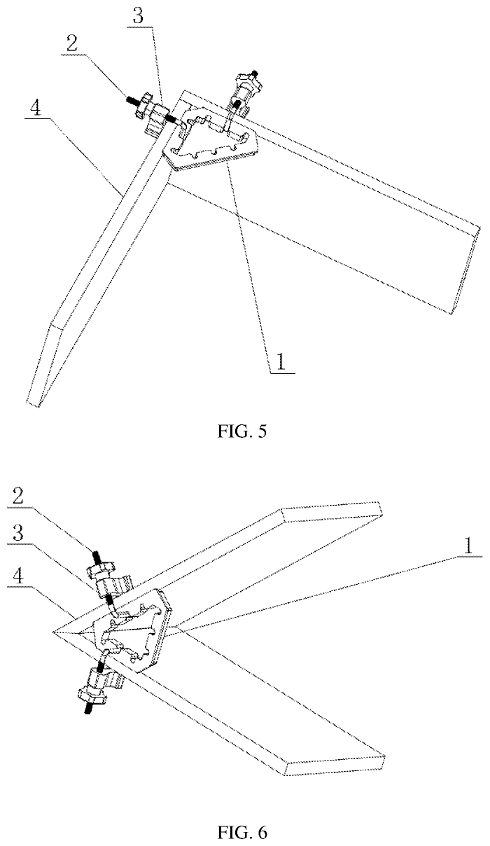

In one case, when connecting two plates 4 at 90 degrees, as shown in FIG. 5, the two plates 4 are respectively abutted against the outer side surfaces where two right-angled sides of the right-angled triangle shape positioning block 1 are located, and then positions of the clampers 3 are adjusted and the plates 4 are locked between the clampers 3 and the outer side surfaces of the right-angled triangle shaped positioning block 1 by using the locking nuts 12, and afterwards the two plates 4 can be fixed together by bonding/cementing or welding.

In another case, when connecting two plates 4 at 45 degrees, as shown in FIG. 6, one of the two plates 4 is abutted against the outer side surface where one of right-angled sides of the right-angled triangle shaped positioning block 1 is located, and the other one of the two plates 4 is abutted against the outer side surface where an oblique side of the right-angled triangle shaped positioning block 1 is located, and then positions of the clampers 3 are adjusted and the plates 4 are locked between the clampers 3 and the outer side surfaces of the right-angled triangle shaped positioning block 1 by using the locking nuts 12, and afterwards the two plates 4 can be fixed together by bonding or welding.

The embodiments of the disclosure each provide a special fixture for plates connection. Each the fixture can complete at most three angles of plate connections, including one right-angled connection and two acute-angled connections. Multiple (i.e., more than one) sets of angle fixing fixtures can be made/fabricated according to needs to meet the requirements of right-angled connection and arbitrary acute-angled connection of plates. The structure is simple and it is easy to use.

What is claimed is:

1. An angle fixing fixture comprising:
a right-angled triangle shaped positioning block; and
clamping claws, wherein each of the clamping claws is disposed with a clamper and a position of the clamper on the clamping claw is adjustable, each of the clamping claws is detachably connected to the right-angled triangle shaped positioning block, the clamper is located outside of the right-angled triangle shaped positioning block and a certain distance is left between the clamper and the right-angled triangle shaped positioning block, and an end surface of an end of the clamper close to the right-angled triangle shaped positioning block is parallel to one of outer side surfaces of the right-angled triangle shaped positioning block;
wherein the number of the clamping claws is at least two.

2. The angle fixing fixture according to claim 1, wherein three corners of the right-angled triangle shaped positioning block are respectively formed with chamfers.

3. The angle fixing fixture according to claim 1, wherein each of the clamping claws is a L-shaped screw rod, the clamper is slidably connected to the L-shaped screw rod, the right-angled triangle shaped positioning block is formed with an insertion hole matched with the L-shaped screw rod, the L-shaped screw rod is disposed with a locking nut, and the locking nut is located at a side of the clamper away from the insertion hole.

4. The angle fixing fixture according to claim 3, wherein a middle portion of the right-angled triangle shaped positioning block is formed with a triangular hole, and the insertion hole is a U-shaped hole formed on an inner wall of the triangular hole and communicated with the triangular hole.

5. The angle fixing fixture according to claim 4, wherein each of three inner walls of the triangular hole is formed with more than one the U-shaped hole.

6. The angle fixing fixture according to claim 3, wherein the locking nut is a knob nut.

7. The angle fixing fixture according to claim 1, wherein one of acute angles of the right-angled triangle shaped positioning block is 45 degrees.

8. The angle fixing fixture according to claim 1, wherein one of acute angles of the right-angled triangle shaped positioning block is 30 degrees.

9. The angle fixing fixture according to claim 1, wherein each of three sides of the right-angled triangle shaped positioning block is formed with a scale.

10. The angle fixing fixture according to claim 1, wherein a top end of the right-angled triangle shaped positioning block is formed with a flange extending outward.

11. The angle fixing fixture according to claim 3, wherein a middle portion of the right-angled triangle shaped positioning block is formed with a triangular hole, and the insertion hole is spaced from the triangular hole.
